(19) United States
(12) Patent Application Publication
(10) Pub. No.: US 2026/0105776 A1
(43) Pub. Date: Apr. 16, 2026

(54) AUTHENTICATION DEVICE, AUTHENTICATION METHOD, AND RECORDING MEDIUM

(71) Applicant: NEC Corporation, Minato-ku, Tokyo (JP)

(72) Inventor: Toshinobu OGATSU, Tokyo (JP)

(73) Assignee: NEC Corporation, Minato-ku, Tokyo (JP)

(21) Appl. No.: 19/105,076

(22) PCT Filed: Sep. 29, 2022
(86) PCT No.: PCT/JP2022/036533

§ 371 Date: Feb. 20, 2025

(51) Int. Cl. G06V 40/16; G06F 21/32; G06V 10/14

(52) U.S. Cl. CPC G06V 40/172; G06F 21/32; G06V 10/14

(57) ABSTRACT

An authentication device includes a light source irradiating light, a reflecting sheet reflecting the light irradiated from the light source, and a camera capturing an image of a subject irradiated with the light that has been reflected by the reflecting sheet, and performs biometric authentication using the image of the subject that has been captured by the camera

### TECHNICAL FIELD

The present disclosure relates to an authentication device, an authentication method, and a recording medium.

### BACKGROUND ART

In a case where capturing an image of a person, such as an image of a face, light from a light source is sometimes irradiated with respect to a person representing a capture subject.

For example, in the verification device described in Patent Document 1, an LED (Light Emitting Diode) lamp is provided on a front frame of a casing, which irradiates light with respect to a person representing a capture subject positioned on the front side.

### PRIOR ART DOCUMENTS

### Patent Document

Patent Document 1: Japanese Unexamined Patent Application, First Publication No. 2019-149204

### SUMMARY OF INVENTION

### Problems to be Solved by the Invention

In a case where an authentication subject is captured in biometric authentication, such as face recognition, the authentication subject needs to be brightly illuminated to a certain extent. On the other hand, it is preferable to reduce the glare experienced by the authentication subject as much as possible.

An example object of the present disclosure is to provide an authentication device, an authentication method, and a recording medium that are capable of solving the above problem.

### Means for Solving the Problem

According to a first example aspect of the present disclosure, an authentication device includes: an illuminating means that irradiates light; a reflecting means that reflects light irradiated from the illuminating means; an image-capturing means that captures an image of a subject irradiated with light that has been reflected by the reflecting means; and an authenticating means that performs biometric authentication using an image of a subject that has been captured by the image-capturing means.

According to a second example aspect of the present disclosure, an authentication method causes an authentication device to perform the steps of: controlling an angle formed between an irradiation direction of light from an illuminating means that irradiates light, and a reflecting surface of a reflecting means that reflects light irradiated from the illuminating means; capturing an image of a subject irradiated with light that has been reflected by the reflecting means; and performing biometric authentication using an image that has been captured of a subject.

According to a third example aspect of the present disclosure, a recording medium stores a program that causes a computer to execute the steps of: controlling an angle formed between an irradiation direction of light from an illuminating means that irradiates light, and a reflecting surface of a reflecting means that reflects light irradiated from the illuminating means; and performing biometric authentication using an image that has been captured of a subject irradiated with light that has been reflected by the reflecting means.

### BRIEF DESCRIPTION OF DRAWINGS

FIG. 1 is a diagram showing an example of a configuration of an authentication device according to a first example embodiment.

FIG. 2 is a diagram showing an example of an external shape of the authentication device according to the first example embodiment.

FIG. 3 is a diagram showing an example of an arrangement of an illuminating unit according to the first example embodiment.

FIG. 4 is a diagram showing an example of a configuration of an authentication device according to a second example embodiment.

FIG. 5 is a diagram showing an example of a configuration of an authentication device according to a third example embodiment.

FIG. 6 is a diagram showing an example of the processing procedure of an authentication method according to a fourth example embodiment.

FIG. 7 is a schematic block diagram showing a configuration of a computer according to at least one example embodiment.

### EXAMPLE EMBODIMENTS

Hereunder, example embodiments will be described. However, the following example embodiments do not limit the invention according to the claims. Furthermore, not all combinations of features described in the example embodiments are essential to the solution means of the invention.

### First Example Embodiment

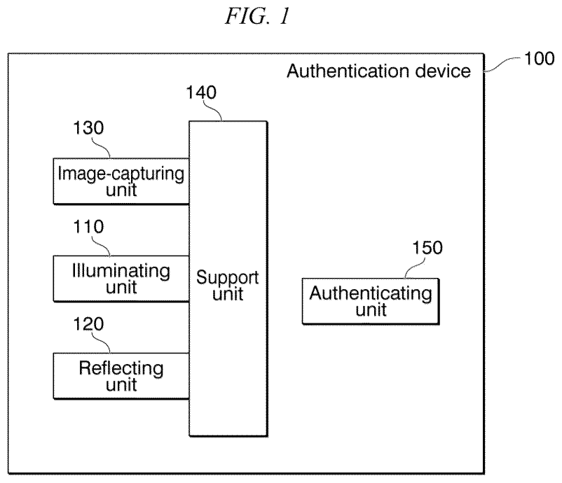

FIG. 1 is a diagram showing an example of a configuration of an authentication device according to a first example embodiment. In the configuration shown in FIG. 1, the authentication device 100 includes an illuminating unit 110, a reflecting unit 120, an image-capturing unit 130, a support unit 140, and an authenticating unit 150.

The authentication device 100 performs biometric authentication of an authentication subject. Specifically, the authentication device 100 irradiates the authentication subject with light, captures an image of the authentication subject that has been irradiated with light, and performs biometric authentication using an image that has been captured of the authentication subject.

The authentication subject is also simply referred to as a subject.

The illuminating unit 110 irradiates light. The illuminating unit 110 corresponds to an example of an illuminating means.

The type of light source that constitutes the illuminating unit 110 is not limited to a specific type. For example, the illuminating unit 110 may be configured using an illuminating device that uses an LED (Light Emitting Diode), but it is not limited to this.

The reflecting unit 120 reflects the light irradiated from the illuminating unit 110. The reflecting unit 120 corresponds to an example of a reflecting means.

As a result of irradiating the authentication subject with light from the illuminating unit 110 that has been reflected by the reflecting unit 120, it is thought that, relative to a case where the authentication subject is directly irradiated with light from a light source, the traveling direction of the light is dispersed to a certain extent by being reflected. Here, the traveling direction of the light being dispersed refers to the light traveling in not just one direction, but in various directions.

The light from the illuminating unit 110 that has been reflected by the reflecting unit 120 is also referred to as light from the illuminating unit 110 and the reflecting unit 120.

As a result of the traveling direction of the light being dispersed, the range in which the light irradiates the authentication subject becomes relatively wide. In this respect, according to the authentication device 100, it is expected that the authentication subject can be brightly illuminated to a certain extent, while reducing the glare experienced by the authentication subject as much as possible.

Furthermore, as a result of the reflecting unit 120 receiving and reflecting the light from the illuminating unit 110 in a region having a certain width (area), it is expected that the authentication subject will be irradiated with light from various directions. As a result, it is expected that shadows will be unlikely to form, or will be relatively faint in the capture image of the authentication subject. As a result of shadows being unlikely to form, or being relatively faint in the capture image of the authentication subject, it is expected that the authentication device 100 will be capable of performing biometric authentication with a relatively high accuracy.

In this way, experiments have revealed that, in a case where the authentication subject is directly irradiated with light from the illuminating unit 110, a case where the authentication subject is irradiated with light from the illuminating unit 110 after being reflected by the reflecting unit 120 is more advantageous for biometric authentication because shadows are less likely to be formed in the capture image.

The reflecting unit 120 may be configured to diffusely reflect the light irradiated from the illuminating unit 110. For example, the reflecting unit 120 may be coated with a white matte paint. Alternatively, the reflecting unit 120 may be configured using a sheet that diffusely reflects light, such as a porous sheet. Alternatively, the reflecting unit 120 may be configured using a semi-transparent material, and may diffusely reflect light due to the Tyndall effect.

As a result of the reflecting unit 120 diffusely reflecting the light irradiated from the illuminating unit 110, the dispersion in the traveling direction of the light described above becomes more pronounced. In this respect, it is expected that the effect described above, in which the authentication subject can be brightly illuminated to a certain extent, while reducing the glare experienced by the authentication subject as much as possible, will be more pronounced. Furthermore, as a result of shadows being unlikely to form, or being relatively faint in the capture image of the authentication subject, it is expected that the effect described above, in which the authentication device 100 is capable of performing biometric authentication with a relatively high accuracy, will be more pronounced.

A case where the authentication device 100 performs face recognition will be described below as an example. In this case, the authentication device 100 irradiates the authentication subject's face with light from the illuminating unit 110 and the reflecting unit 120. For example, an instruction may be provided to the authentication subject to stand in front of the authentication device 100, and orient the face toward the authentication device 100.

However, the biometric authentication performed by the authentication device 100 is not limited to face recognition, and can be various types of biometric authentication performed using an image that has been captured of an authentication subject.

Furthermore, the authentication device 100 may perform biometric authentication using a plurality of methods. For example, the authentication device 100 may perform face recognition using visible light from the illuminating unit 110 and the reflecting unit 120, and perform iris authentication using infrared light from an infrared light source such as an infrared LED in addition to the light from the illuminating unit 110 and the reflecting unit 120. In this case, the authentication device 100 may perform iris authentication by irradiating the vicinity of the authentication subject's eyes with infrared light from a regular infrared light source, and capturing an image of the authentication subject's eyes with an infrared camera.

The image-capturing unit 130 captures an image of a subject irradiated with light that has been reflected by the reflecting unit 120. The image-capturing unit 130 corresponds to an example of an image-capturing means. The image-capturing unit 130 is configured using a digital camera, and may convert incident light into an image signal.

The image of the authentication subject's face that has been captured by the image-capturing unit 130 is used for face recognition by the authenticating unit 150.

Moreover, in a case where the authentication device 100 performs iris authentication using an infrared light source and an infrared camera, the position of the authentication subject's eyes may be identified from a capture image from the image-capturing unit 130. Further, the authentication device 100 may control the orientation of the infrared light source (the irradiation direction of the infrared light from the infrared light source) and the orientation of the infrared camera (the direction in which the infrared camera captures images) based on the identified position of the authentication subject's eyes.

The support unit 140 supports the illuminating unit 110, the reflecting unit 120, and the image-capturing unit 130. For example, the support unit 140 supports the illuminating unit 110 and the reflecting unit 120 in a position and orientation that causes the face of the authentication subject that is standing in a specified position and orientation to be irradiated with light from the illuminating unit 110 and the reflecting unit 120. Furthermore, the support unit 140 supports the image-capturing unit 130 in a position and orientation that captures the authentication subject's face that is being irradiated with light from the illuminating unit 110 and the reflecting unit 120.

The support unit 140 may be configured to support the illuminating unit 110, the reflecting unit 120, and the image-capturing unit 130, such that the positions and orientations are fixed. Alternatively, as described below in a second example embodiment, a drive unit may be provided that changes at least one of the position or orientation of the illuminating unit 110, the position or orientation of the reflecting unit 120, the position or orientation of the image-capturing unit 130, or a combination thereof, according to a condition such as the authentication subject's height.

The authenticating unit 150 performs biometric authentication using an image of a subject that has been captured by the image-capturing unit 130. The authenticating unit 150 corresponds to an example of an authenticating means.

As mentioned above with respect to the authentication device 100, a case where the authenticating unit 150 performs face recognition will be described below. However, the biometric authentication performed by the authenticating unit 150 is not limited to face recognition, and can be various types of biometric authentication performed using an image that has been captured of an authentication subject.

Furthermore, the method by which the authenticating unit 150 performs biometric authentication, such as the algorithm used by the authenticating unit 150 to perform biometric authentication, is not limited to a specific method. For example, the authenticating unit 150 may perform face recognition using a known face recognition algorithm.

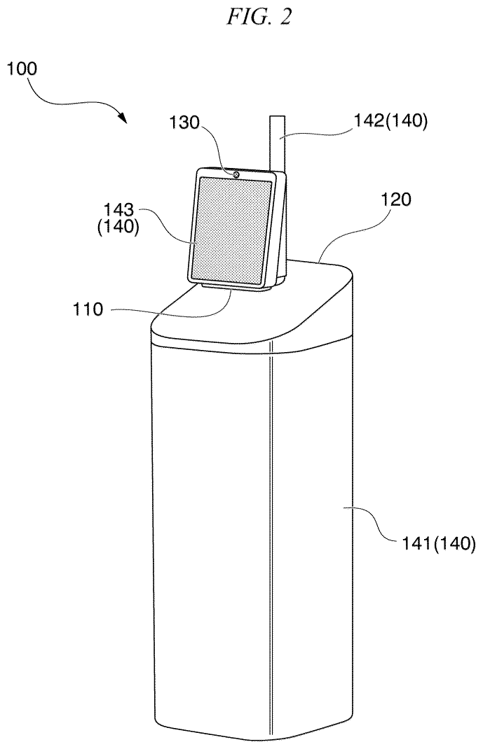

FIG. 2 is a diagram showing an example of an external shape of the authentication device 100. In the example of FIG. 2, the support unit 140 includes a stand 141, a support column 142, and a storage case 143. The support column 142 is provided on an upper portion of the stand 141, and the storage case 143 is attached to the support column 142.

Furthermore, in the example of FIG. 2, an upper plate of the stand 141 corresponds to the reflecting unit 120. An upper surface of the stand 141 (that is to say, an upper surface of the upper plate) reflects light from the illuminating unit 110. The surface that reflects light from the illuminating unit 110 is also referred to as a reflecting surface.

The illuminating unit 110 and the image-capturing unit 130 are provided in the storage case 143.

A display screen may be provided on a front surface of the storage case 143, such that instructions and the like to the authentication subject are displayed, but it is not limited to this.

The illuminating unit 110 is provided on a lower portion of the storage case 143, and irradiates light in an approximately downward direction.

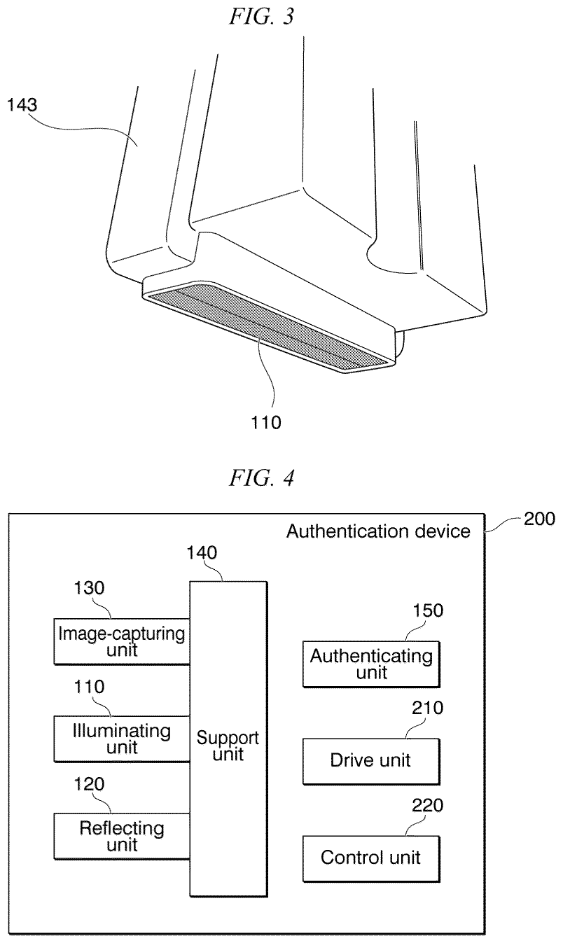

FIG. 3 is a diagram showing an example of the arrangement of the illuminating unit 110. In the example of FIG. 3, the illuminating unit 110 is provided on a lower surface of the storage case 143.

The reflecting unit 120 is arranged with an incline such that the face of the authentication subject standing in front of the authentication device 100 is irradiated with light from the illuminating unit 110 and the reflecting unit 120. For example, the reflecting unit 120 may be arranged having an incline of approximately 20 degrees such that the side toward the front of the authentication device 100 is lower, and the side toward the rear is higher. The irradiation direction of the light from the illuminating unit 110 may also be inclined with respect to a straight downward direction, and may be inclined toward the front side of the authentication device 100 relative to a straight downward direction, and the like.

In the example of FIG. 2, the reflecting unit 120 is arranged such that light is directed toward the authentication subject's face from the lower front side (diagonally forward and downward) of the authentication subject's face. In this case, the reflecting unit 120 is provided at a lower position than the height of the authentication subject's face, and in this respect, it is expected that the authentication subject will not experience a sense of intimidation.

Furthermore, because the authentication device 100 irradiates light toward the authentication subject's face from a lower front side of the authentication subject's face, it is expected that shadows, such as a shadow under the nose or a shadow on the cheeks, will be unlikely to form, or will be relatively faint, in the capture image of the authentication subject. As a result of shadows being unlikely to form, or being relatively faint in the capture image of the authentication subject, as mentioned above, it is expected that the authentication device 100 will be capable of performing biometric authentication with a relatively high accuracy.

Furthermore, because the authentication device 100 irradiates light from a lower position than the height of the line of sight of a standing person, it is expected that, for the standing person, the light from the illuminating unit 110 and the reflecting unit 120 will be relatively unnoticeable. For example, even in a case where the authentication device 100 is arranged in a relatively dark location, such as a hall with reduced lighting, it is expected that the authentication device 100 will not spoil the atmosphere of the arrangement location.

In addition, the width of the reflecting unit 120 may be slightly wider than the width of a person's face such that the light from the illuminating unit 110 and the reflecting unit 120 irradiates a relatively narrow range that is about the size of a person's face or slightly larger than a person's face. As a result, it is expected that the light from the illuminating unit 110 and the reflecting unit 120 will become even more unnoticeable, and the atmosphere of the arrangement location of the authentication device 100 will not be spoiled.

However, the arrangement of the illuminating unit 110 and the reflecting unit 120 is not limited to a specific arrangement. Furthermore, the illuminating unit 110 may be provided on both left and right side surface sections of the storage case 143, and the reflecting unit 120 may be provided on a side surface of the illuminating unit 110 (both outer sides), such that light is irradiated from both sides from diagonally in front of the authentication subject's face. Alternatively, the illuminating unit 110 may be provided on an upper section of the storage case 143, and the reflecting unit 120 may be provided on an upper surface of the illuminating unit 110, such that light is irradiated from both sides from diagonally in front of the authentication subject's face. Alternatively, the illuminating unit 110 may irradiate light in each of the up, down, left, and right directions of the storage case 143. In addition, the reflecting unit 120 may be arranged so as to surround the storage case 143. As a result, the authentication device 100 may irradiate the authentication subject's face with light from each of the diagonally upward, diagonally downward, diagonally left, and diagonally right directions in front of the authentication subject's face.

In addition, the size of the illuminating unit 110 and the reflecting unit 120 is not limited to a specific size. For example, the stand 141 may also serve as a writing stand, and the width of the reflecting unit 120 may be larger than the size mentioned above that is slightly wider than the width of a person's face. In this case, the illuminating unit 110 may irradiate light toward a region of a portion of the upper surface of the stand 141 that constitutes the reflecting unit 120.

The reflecting surface of the reflecting unit 120 may be flat, or may be curved. For example, the reflecting surface of the reflecting unit 120 may be curved in a concave shape.

Here, consider a case where, if the reflective surface were flat, the reflected light from the illuminating unit 110 would be spread far beyond the region of the authentication subject's face. In this case, as a result of the reflective surface being curved in a concave shape, it is expected that the reflected light from the illuminating unit 110 will become focused so as to illuminate the vicinity of the authentication subject's face. Consequently, the authentication device 100 is capable of illuminating the authentication subject's face relatively brightly, and it is expected that the authenticating unit 150 will be capable of performing face recognition with a relatively high accuracy. Furthermore, because the spread of the light becomes small, it is expected that the atmosphere of the arrangement location of the authentication device 100 will not be spoiled.

Moreover, in FIG. 2, the position of the lens of the image-capturing unit 130 is shown. The image-capturing unit 130 is accommodated inside the storage case 143 so as to face approximately the front of the authentication device 100 in a case where performing capture.

The computer that executes the functions of the authenticating unit 150 may be accommodated inside the stand 141 or inside the storage case 143. Alternatively, the computer that executes the functions of the authenticating unit 150 may be provided on the outside of the stand 141, the support column 142, and the storage case 143, and may acquire capture images from the image-capturing unit 130 by wired communication or wireless communication.

As described above, the illuminating unit 110 irradiates light. The reflecting unit 120 reflects the light irradiated from the illuminating unit 110. The image-capturing unit 130 captures an image of a subject irradiated with light that has been reflected by the reflecting unit 120. The authenticating unit 150 performs biometric authentication using an image of a subject that has been captured by the image-capturing unit 130.

As a result of irradiating the authentication subject with light from the illuminating unit 110 that has been reflected by the reflecting unit 120, it is thought that the traveling direction of the light is dispersed to a certain extent by being reflected, relative to a case where the authentication subject is directly irradiated with light from a light source. As a result of the traveling direction of the light being dispersed, the range in which the light irradiates the authentication subject becomes relatively wide. In this respect, according to the authentication device 100, it is expected that the authentication subject can be brightly illuminated to a certain extent, while reducing the glare experienced by the authentication subject as much as possible.

Furthermore, as a result of the reflecting unit 120 receiving and reflecting the light from the illuminating unit 110 in a region having a certain width (area), it is expected that the authentication subject will be irradiated with light from various directions. As a result, it is expected that shadows will be unlikely to form, or will be relatively faint in the capture image of the authentication subject. As a result of shadows being unlikely to form, or being relatively faint in the capture image of the authentication subject, it is expected that the authenticating unit 150 will be capable of performing biometric authentication with a relatively high accuracy.

Furthermore, the reflecting unit 120 is configured to diffusely reflect the light irradiated from the illuminating unit 110.

As a result of the reflecting unit 120 diffusely reflecting the light irradiated from the illuminating unit 110, the dispersion in the traveling direction of the light described above becomes more pronounced. In this respect, it is expected that the effect described above, in which the authentication subject can be brightly illuminated to a certain extent, while reducing the glare experienced by the authentication subject as much as possible, will be more pronounced. Moreover, as a result of shadows being unlikely to form, or being relatively faint in the capture image of the authentication subject, it is expected that the effect described above, in which the authenticating unit 150 is capable of performing biometric authentication with a relatively high accuracy, will be more pronounced.

In addition, the reflecting unit 120 is arranged such that light is directed toward the authentication subject's face from the lower front side of the authentication subject's face. The authenticating unit 150 performs face recognition.

In this case, the reflecting unit 120 is provided at a lower position than the height of the authentication subject's face, and in this respect, it is expected that the authentication subject will not feel a sense of intimidation.

Furthermore, because the authentication device 100 irradiates light toward the authentication subject's face from a lower front side of the authentication subject's face, it is expected that shadows, such as a shadow under the nose or a shadow on the cheeks, will be unlikely to form, or will be relatively faint, in the capture image of the authentication subject. As a result of shadows being unlikely to form, or being relatively faint in the capture image of the authentication subject, as mentioned above, it is expected that the authenticating unit 150 will be capable of performing biometric authentication with a relatively high accuracy.

Furthermore, because the authentication device 100 irradiates light from a lower position than the height of the line of sight of a standing person, it is expected that, for the standing person, the light from the illuminating unit 110 and the reflecting unit 120 will be relatively unnoticeable. For example, even in a case where the authentication device 100 is arranged in a relatively dark location, such as a hall with reduced lighting, it is expected that the authentication device 100 will not spoil the atmosphere of the arrangement location.

### Second Example Embodiment

The authentication device may change at least one of the position or orientation of the illuminating unit 110, the position or orientation of the reflecting unit 120, the position or orientation of the image-capturing unit 130, or a combination thereof, according to a condition such as the authentication subject's height. This example aspect will be described in the second example embodiment.

FIG. 4 is a diagram showing an example of a configuration of an authentication device according to a second example embodiment. In the configuration shown in FIG. 4, the authentication device 200 includes an illuminating unit 110, a reflecting unit 120, an image-capturing unit 130, a support unit 140, an authenticating unit 150, a drive unit 210, and a control unit 220.

Of the units in FIG. 4, those units having the same functions as the units shown in FIG. 1 are designated by the same reference symbols (110, 120, 130, 140, and 150), and a detailed description will be omitted here.

The authentication device 200 includes the drive unit 210 and the control unit 220 in addition to the units provided in the authentication device 100. The authentication device 200 is the same as the authentication device 100 in all other respects.

The drive unit 210 changes at least one of the position or orientation of the illuminating unit 110, the position or orientation of the reflecting unit 120, the position or orientation of the image-capturing unit 130, or a combination thereof. For example, the drive unit 210 may be configured using a servo motor.

The control unit 220 controls at least one of the position or orientation of the illuminating unit 110, the position or orientation of the reflecting unit 120, the position or orientation of the image-capturing unit 130, or a combination thereof. As a result, the control unit 220 controls an angle formed between the irradiation direction of the light from the illuminating unit 110, and the reflecting surface of the reflecting unit 120. The control unit 220 corresponds to an example of a control means.

For example, the control unit 220 may control the orientation of the reflecting surface of the reflecting unit 120 by controlling the drive unit 210 based on one or both of the authentication subject's height and the distance from the reflecting unit 120 to the authentication subject. Further, for example, the control unit 220 may control the inclination angle of the reflecting surface of the reflecting unit 120. As a result, the control unit 220 may adjust the orientation of the reflecting surface of the reflecting unit 120, such that the authentication subject's face is irradiated with light from the illuminating unit 110 and the reflecting unit 120.

In order to perform such a control, the control unit 220 may store, in advance, data in a table format in which one or both of the authentication subject's height and the distance from the reflecting unit 120 to the authentication subject are associated with the orientation in which the reflecting surface of the reflecting unit 120 is to be oriented.

Alternatively, the control unit 220 may be configured by including a machine learning model such as a neural network, and the relationship between one or both of the authentication subject's height and the distance from the reflecting unit 120 to the authentication subject, and the orientation in which the reflecting surface of the reflecting unit 120 is to be oriented, may be learned in advance.

In addition, for example, the control unit 220 may learn the relationship between one or both of the authentication subject's height and the distance from the reflecting unit 120 to the authentication subject, and the orientation in which the reflecting surface of the reflecting unit 120 is to be oriented, by using an index that represents the accuracy of authentication by the authenticating unit 150 as an objective function, such that the accuracy of authentication indicated by the objective function becomes as high as possible.

The control unit 220 may detect one or both of the authentication subject's height, and the distance from the reflecting unit 120 to the authentication subject based on the capture image from the image-capturing unit 130. Alternatively, the authentication device 200 may include, in addition to the image-capturing unit 130, a sensor for detecting one or both of the authentication subject's height and the distance from the reflecting unit 120 to the authentication subject.

Alternatively, the control unit 220 may adjust the orientation of the reflecting surface of the reflecting unit 120 such that the authentication subject's face is irradiated with light from the illuminating unit 110 and the reflecting unit 120 while referring to the capture image from the image-capturing unit 130.

Alternatively, the control unit 220 may control the orientation of the illuminating unit 110 by controlling the drive unit 210 based on one or both of the authentication subject's height and the distance from the reflecting unit 120 to the authentication subject. Specifically, the control unit 220 may control the orientation of the light irradiated by the illuminating unit 110 by controlling the orientation of the illuminating unit 110. As a result, the control unit 220 may adjust the orientation of the illuminating unit 110 such that the authentication subject's face is irradiated with light from the illuminating unit 110 and the reflecting unit 120.

In order to perform such a control, the control unit 220 may store, in advance, data in a table format in which one or both of the authentication subject's height and the distance from the reflecting unit 120 to the authentication subject are associated with the orientation in which the reflecting surface of the illuminating unit 110 is to be oriented.

Alternatively, the control unit 220 may be configured by including a machine learning model such as a neural network, and the relationship between one or both of the authentication subject's height and the distance from the reflecting unit 120 to the authentication subject, and the orientation in which the reflecting surface of the illuminating unit 110 is to be oriented, may be learned in advance.

In addition, for example, the control unit 220 may learn the relationship between one or both of the authentication subject's height and the distance from the reflecting unit 120 to the authentication subject, and the orientation in which the illuminating unit 110 is to be oriented, by using an index that represents the accuracy of authentication by the authenticating unit 150 as an objective function, such that the accuracy of authentication indicated by the objective function becomes as high as possible.

Alternatively, the control unit 220 may adjust the orientation of the illuminating unit 110 such that the authentication subject's face is irradiated with light from the illuminating unit 110 and the reflecting unit 120 while referring to the capture image from the image-capturing unit 130.

Furthermore, the illuminating unit 110 may be configured to be capable of varying the intensity (brightness) of the emitted light, and the control unit 220 may control the intensity of the light emitted by the illuminating unit 110. For example, the control unit 220 may control the intensity of light emitted by the illuminating unit 110 based on the light environment of the surroundings of the authentication subject and the like, such as the intensity of light from the lighting in the surroundings of the authentication subject.

In order to perform such a control, the control unit 220 may store, in advance, data in a table format in which the brightness of the authentication subject's face that appears in the capture image from the image-capturing unit 130 in a state where the illuminating unit 110 is not irradiating light, is associated with the intensity of the light to be irradiated by the illuminating unit 110.

Further, the control unit 220 may determine the intensity of the light to be irradiated by the illuminating unit 110 based on the brightness of the authentication subject's face that appears in the capture image from the image-capturing unit 130, in a state where the illuminating unit 110 is not irradiating light.

Alternatively, the control unit 220 may be configured by including a machine learning model such as a neural network, and learn, in advance, the relationship between the brightness of the authentication subject's face that appears in the capture image from the image-capturing unit 130 in a state where the illuminating unit 110 is not irradiating light, and the intensity of the light to be irradiated by the illuminating unit 110.

In addition, for example, the control unit 220 may learn the relationship between the brightness of the authentication subject's face that appears in the capture image from the image-capturing unit 130 in a state where the illuminating unit 110 is not irradiating light, and the intensity of the light to be irradiated by the illuminating unit 110, by using an index that represents the accuracy of authentication by the authenticating unit 150 as an objective function, such that the accuracy of authentication indicated by the objective function in a state where the illuminating unit 110 is irradiating light becomes as high as possible.

Alternatively, the control unit 220 may control the intensity of the light irradiated by the illuminating unit 110 while referring to an index value indicating the accuracy of authentication by the authenticating unit 150, such that the accuracy of authentication by the authenticating unit 150 becomes as high as possible.

The computer that executes the functions of the authenticating unit 150 may also execute the functions of the control unit 220. Alternatively, the authentication device 100 may include a computer that executes the functions of the control unit 220 in addition to the computer that executes the functions of the authenticating unit 150.

As described above, the control unit 220 controls the angle formed between the irradiation direction of the light from the illuminating unit 110, and the reflecting surface of the reflecting unit 120.

As a result, the authentication device 200 is capable of adjusting the angle formed between the irradiation direction of the light from the illuminating unit 110, and the reflecting surface of the reflecting unit 120, such that the authentication subject's face is irradiated with light from the illuminating unit 110 and the reflecting unit 120. As a result of adjusting the angle between the irradiation direction of the light from the illuminating unit 110, and the reflecting surface of the reflecting unit 120, the authentication subject's face is irradiated with light from the illuminating unit 110 and the reflecting unit 120, and it is expected that the authenticating unit 150 will be capable of performing face recognition with a relatively high accuracy.

### Third Example Embodiment

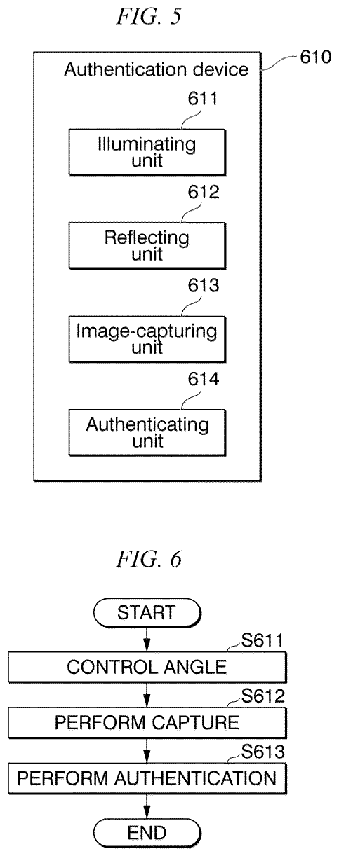

FIG. 5 is a diagram showing an example of a configuration of an authentication device according to a third example embodiment. In the configuration shown in FIG. 5, the authentication device 610 includes an illuminating unit 611, a reflecting unit 612, an image-capturing unit 613, and an authenticating unit 614.

In such a configuration, the illuminating unit 611 irradiates light. The reflecting unit 612 reflects the light irradiated from the illuminating unit 611. The image-capturing unit 613 captures an image of a subject irradiated with light that has been reflected by the reflecting unit 612. The authenticating unit 614 performs biometric authentication using an image of a subject that has been captured by the image-capturing unit 613.

The illuminating unit 611 corresponds to an example of an illuminating means. The reflecting unit 612 corresponds to an example of a reflecting means. The image-capturing unit 613 corresponds to an example of an image-capturing means. The authenticating unit 614 corresponds to an example of an authenticating means.

As a result of irradiating the authentication subject with light from the illuminating unit 611 that has been reflected by the reflecting unit 612, it is thought that the traveling direction of the light is dispersed to a certain extent by being reflected, relative to a case where the authentication subject is directly irradiated with light from a light source. As a result of the traveling direction of the light being dispersed, the range in which the light irradiates the authentication subject becomes relatively wide. In this respect, according to the authentication device 610, it is expected that the authentication subject can be brightly illuminated to a certain extent, while reducing the glare experienced by the authentication subject as much as possible.

Furthermore, as a result of the reflecting unit 612 receiving and reflecting the light from the illuminating unit 611 in a region having a certain width (area), it is expected that the authentication subject will be irradiated with light from various directions. As a result, it is expected that shadows will be unlikely to form, or will be relatively faint in the capture image of the authentication subject. As a result of shadows being unlikely to form, or being relatively faint in the capture image of the authentication subject, it is expected that the authenticating unit 614 will be capable of performing biometric authentication with a relatively high accuracy.

### Fourth Example Embodiment

FIG. 6 is a diagram showing an example of the processing procedure of an authentication method according to a fourth example embodiment.

The authentication method shown in FIG. 6 includes controlling an angle (step S611), performing capture (step S612), and performing authentication (step S613).

In the step of controlling an angle (step S611), the authentication device controls an angle formed between an irradiation direction of light from an illuminating means that irradiates light, and a reflecting surface of a reflecting means that reflects light irradiated from the illuminating means. In the step of performing capture (step S612), an authentication device captures an image of a subject irradiated with light that has been reflected by the reflecting means. In the step of performing authentication (step S613), an authentication device performs biometric authentication using an image that has been captured of a subject.

According to the authentication method shown in FIG. 6, as a result of irradiating the authentication subject with light from the illuminating means that has been reflected by the reflecting means, it is thought that the traveling direction of the light is dispersed to a certain extent by being reflected, compared to a case where the authentication subject is directly irradiated with light from a light source. As a result of the traveling direction of the light being dispersed, the range in which the light irradiates the authentication subject becomes relatively wide. In this respect, according to the authentication method shown in FIG. 6, it is expected that the authentication subject can be brightly illuminated to a certain extent, while reducing the glare experienced by the authentication subject as much as possible.

Furthermore, as a result of the reflecting means receiving and reflecting the light from the illuminating means in a region having a certain width (area), it is expected that the authentication subject will be irradiated with light from various directions. As a result, it is expected that shadows will be unlikely to form, or will be relatively faint in the capture image of the authentication subject. As a result of shadows being unlikely to form, or being relatively faint in the capture image of the authentication subject, it is expected that the authentication device will be capable of performing biometric authentication with a relatively high accuracy.

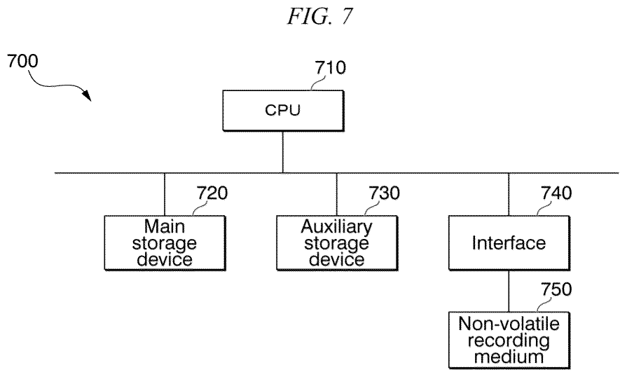

FIG. 7 is a schematic block diagram showing a configuration of a computer according to at least one example embodiment.

In the configuration shown in FIG. 7, a computer 700 includes a CPU 710, a main storage device 720, an auxiliary storage device 730, an interface 740, and a non-volatile recording medium 750.

The functions of any one or more of the authenticating unit 150, the control unit 220, and the authenticating unit 614 described above, or a portion thereof, may be implemented by the computer 700. In this case, the operation of each of the processing units described above is stored in the auxiliary storage device 730 in the form of a program. The CPU 710 reads the programs from the auxiliary storage device 730, expands the programs in the main storage device 720, and executes the processing described above according to the programs. Furthermore, the CPU 710 secures a storage area in the main storage device 720 for each processing unit to perform processing according to the programs. The communication for executing the functions of each processing unit is executed as a result of the interface 740 having a communication function, and performing communication according to the control of the CPU 710. The interactions with the user for executing the functions of each processing unit are executed as a result of the interface 740 having a display device and an input device, various images being displayed according to control by the CPU 710, and accepting user operations.

One or more of the programs described above may be recorded in the non-volatile recording medium 750. In this case, the interface 740 may read out the program from the non-volatile recording medium 750. Then, the CPU 710 may directly execute the program that has been read out by the interface 740, or execute the program after temporarily saving the program in the main storage device 720 or the auxiliary storage device 730.

Furthermore, a program for executing some or all of the processing performed by the authenticating unit 150, the control unit 220, and the authenticating unit 614 may be recorded in a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

Example embodiments have been described in detail above with reference to the drawings. However, specific configurations are in no way limited to the example embodiments, and include designs and the like within a scope not departing from the spirit of the present disclosure.

A part or all of the example embodiments above can be written as in the supplementary notes below, but is not limited thereto.

### (Supplementary Note 1)

An authentication device including:
an illuminating means that irradiates light;
a reflecting means that reflects light irradiated from the illuminating means;
an image-capturing means that captures an image of a subject irradiated with light that has been reflected by the reflecting means; and
an authenticating means that performs biometric authentication using an image of a subject that has been captured by the image-capturing means.
   (supplementary Note 2)

The authentication device according to supplementary note 1, wherein
the reflecting means diffusely reflects light irradiated from the illuminating means.
   (supplementary Note 3)

The authentication device according to supplementary note 1 or 2, wherein
the reflecting means is arranged such that light is directed toward an authentication subject's face from a lower front side of the authentication subject's face, and
the authenticating means performs face recognition.

### (Supplementary Note 4)

The authentication device according to any one of supplementary notes 1 to 3, further comprising
a control means that controls an angle formed between an irradiation direction of light from the illuminating means, and a reflecting surface of the reflecting means.
   (supplementary Note 5)

An authentication method, in which an authentication device performs the steps of:
controlling an angle formed between an irradiation direction of light from an illuminating means that irradiates light, and a reflecting surface of a reflecting means that reflects light irradiated from the illuminating means;
capturing an image of a subject irradiated with light that has been reflected by the reflecting means; and
performing biometric authentication using an image that has been captured of a subject.
   (supplementary Note 6)

A recording medium that stores a program that causes a computer to execute the steps of:
controlling an angle formed between an irradiation direction of light from an illuminating means that irradiates light, and a reflecting surface of a reflecting means that reflects light irradiated from the illuminating means; and
performing biometric authentication using an image that has been captured of a subject irradiated with light that has been reflected by the reflecting means.

### INDUSTRIAL APPLICABILITY

The present disclosure may be applied to an authentication device, an authentication method, and a recording medium.

### REFERENCE SIGNS LIST

100, 200, 610 Authentication device
110, 611 Illuminating unit
120, 612 Reflecting unit
130, 613 Image-capturing unit
140 Support unit
141 Stand
142 Support column
143 Storage case
150, 614 Authenticating unit
210 Drive unit
220 Control unit

What is claimed is:

1. An authentication device comprising:
a light source irradiating light;
a reflecting sheet reflecting the reflects light irradiated from the light source;
a camera capturing an image of a subject irradiated with the light that has been reflected by the reflecting sheet;
at least one memory configured to store instructions; and
at least one processor configured to execute the instructions to:
perform biometric authentication using the image of the subject that has been captured by the camera.

2. The authentication device according to claim 1, wherein the reflecting sheet diffusely reflects the light irradiated from the light source.

3. The authentication device according to claim 1, wherein the reflecting sheet is arranged such that the light is directed toward an authentication subject's face from a lower front side of the authentication subject's face, and
wherein the at least one processor is configured to execute the instructions to perform face recognition of the subject.

4. The authentication device according to claim 1, wherein the at least one processor is configured to control
an angle formed between an irradiation direction of the light from the light source, and a reflecting surface of the reflecting sheet.

5. An authentication method executed by an authentication device including a light source, a reflecting sheet, and a camera, the method comprising:
controlling an angle formed between an irradiation direction of light from the light source that irradiates light, and a reflecting surface of the reflecting sheet that reflects the light irradiated from the light source;
capturing, by the camera, an image of a subject irradiated with the light that has been reflected by the reflecting sheet; and
performing biometric authentication using the image that has been captured of the subject.

6. A non-transitory recording medium storing a program that causes a computer of an authentication device to execute:
controlling an angle formed between an irradiation direction of light from a light source that irradiates light, and a reflecting surface of a reflecting sheet that reflects the light irradiated from the light source;
capturing, by a camera, an image of a subject irradiated with the light that has been reflected by the reflecting sheet; and
performing biometric authentication using an image that has been captured of the subject.
